(19) United States
(12) Patent Application Publication
(10) Pub. No.: US 2019/0202677 A1
(43) Pub. Date: Jul. 4, 2019

(54) Method for providing information relating to an apparatus for lifting and/or moving a load

(71) Applicant: O.ME.R. S.p.A., Mirano (IT)

(72) Inventor: Orietta Rossato, Mirano (IT)

(73) Assignee: O.ME.R. S.p.A., Mirano (IT)

(21) Appl. No.: 16/314,692

(22) PCT Filed: Jul. 4, 2017
(86) PCT No.: PCT/IB2017/054032

§ 371 Date: Jan. 2, 2019

(30) Foreign Application Priority Data
Jul. 4, 2016 (IT) 102016000069425

(51) Int. Cl. B66F 9/24; G06K 7/14

(52) U.S. Cl. CPC B66F 9/24; G06K 7/1417

(57) ABSTRACT

A method for providing information related to an apparatus for lifting and/or handling a load, in particular motor vehicles and/or goods, which has a processing unit and a user interface with a display device, includes displaying on the display device at least one two-dimensional matrix barcode, which contains data related to at least one operative working cycle of the apparatus, the at least one two-dimensional matrix barcode being dynamically generated by software loaded and run on the processing unit by encoding the data related to the at least one operative working cycle of the apparatus.

### FIELD OF THE INVENTION

The present invention relates to an improved method for providing information related to an apparatus for lifting a load, particularly motor vehicles and/or goods.

### BACKGROUND OF THE INVENTION

Apparatuses for lifting motor vehicles, which are generally used in workshops to allow operators to access the lower zones of the motor vehicles themselves in order to perform maintenance and/or repair operations under them, are known. Furthermore, such lifting apparatuses are also used in automatic or non-automatic vehicle parking systems, as well as in constructions for lifting and/or moving goods.

Currently, such apparatuses are generally configured to display information in form of messages related to the state or operation of the apparatus itself on a corresponding display, possibly encoding such signaling messages, the meaning of which is then appropriately described in specific manuals.

Therefore, in case of malfunctions and during routine maintenance operations, the operator must orally communicate the messages, i.e. via telephone call, which are shown on the display of the apparatus to the remote service center in order to send information related to the state or operation of the apparatus to a remote service center.

It is easy to understand how such procedure is not satisfactory because, in addition to being slow and laborious, it is also highly dependent on the operator, with a high risk of errors and inaccuracies, in particular in the case of less expert operators.

An apparatus has also been suggested which, either directly or via Bluetooth, accesses a network connection via the Internet and sends the corresponding information related to its operating state to the remote service center.

Such solution is also not entirely satisfactory because it is not always possible to easily connect the apparatus to an appropriate Internet connection, which in all cases requires the provision of an appropriate and dedicated infrastructure, in the workshop. Furthermore, such procedure is not always efficient or appropriately protected in terms of data transmission.

EP 2927186 describes a method for controlling a fork-lift truck, of the type generally used in industrial contexts, which is provided with a graphic display, a control device and a memory element, in which the information necessary for its operation and/or maintenance, are stored. In particular, such method envisages that, on the basis of the operative state and/or of the faults of the industrial fork-lift truck and/or of a request sent by the operator by means of an input device of the fork-lift truck itself, the control device extracts the corresponding useful information from the memory element (database), which information is then shown on the graphic display of the fork-lift truck in form of barcode. In particular, the information extracted from the memory element and used to create the barcode concerns fixed data and values, such as operating, working, repair and/or start-up instructions, configuration parametric and default values of the fork-lift truck, the number of errors/faults, the necessary spare parts, the contact references for servicing, an Internet address and an access code.

Substantially, EP 2927186 uses the operative state of the fork-lift truck to query the memory element, which is present locally on the fork-lift truck itself, in order to extract the corresponding instructions from such memory element and it is these instructions which are then used to create the barcode which is shown on the fork-lift truck screen.

Such solution is rather complicated because it requires providing an appropriate configuration and querying of the storage element, which is locally envisaged on the fork-lift truck. Furthermore, such solution envisages creating the barcode with static type information (e.g. related to the machine configuration parameters), i.e. which are fixed, invariable over time because they are prestored in the memory element.

Furthermore, the fact that in EP 2927186 the operating and maintenance information is extracted from the memory element mounted locally on each machine makes the step of updating such information rather laborious and complicated, since it must be necessarily performed manually by the operator one machine at a time or requires connection means to the Internet to be provided on the apparatus itself, with same drawbacks indicated above.

### SUMMARY OF THE INVENTION

It is the object of the invention to suggest a perfected method to provide information and data related to the state and operation of an apparatus for lifting and/or handling a load, particularly of motor vehicles and goods, which is improving and/or alternative with respect to the traditional ones.

It is another object of the invention to suggest a method which allows rapid, simple and user-friendly acquisition of the data of the apparatus.

It is another object of the invention to suggest a method which allows a protected and secure acquisition and transmission of the state data related to the apparatus.

It is another object of the invention is to suggest a method which is independent from the operator.

It is another object of the invention to suggest a method which makes it possible to perform predictive analysis of the operation of the apparatus.

It is another object of the invention to suggest a method which makes it possible to calibrate and/or perform predictive maintenance of the apparatus.

It is another object of the invention to suggest a method which avoids translating the messages into multiple different languages according to the operators who act on the apparatus itself.

It is another object of the invention to suggest a method with an alternative characterization, in terms of both function and implementation, with respect to the traditional ones.

It is another object of the invention to suggest a method which can be implemented in simple, quick and cost-effective manner.

All these objects, taken individually or in any combination thereof, and others which will be apparent from the following description, are achieved according to the invention by a method and an infrastructure as described hereinafter.

### BRIEF DESCRIPTION OF THE DRAWINGS

The present invention is further explained by means of a preferred embodiment given by way of non-limiting practical example only with reference to the accompanying drawings, in which:

FIG. 1 shows a diagrammatic view of an infrastructure which implements the method according to the invention,

FIG. 2 shows the main screen visible on the display device of the interface of the apparatus according to the invention,

FIG. 3 shows an introductory screen visible on the display device of the interface of the apparatus according to the invention,

FIG. 4 shows an example of the screen visible on the display of the mobile acquisition device used in the method according to the invention.

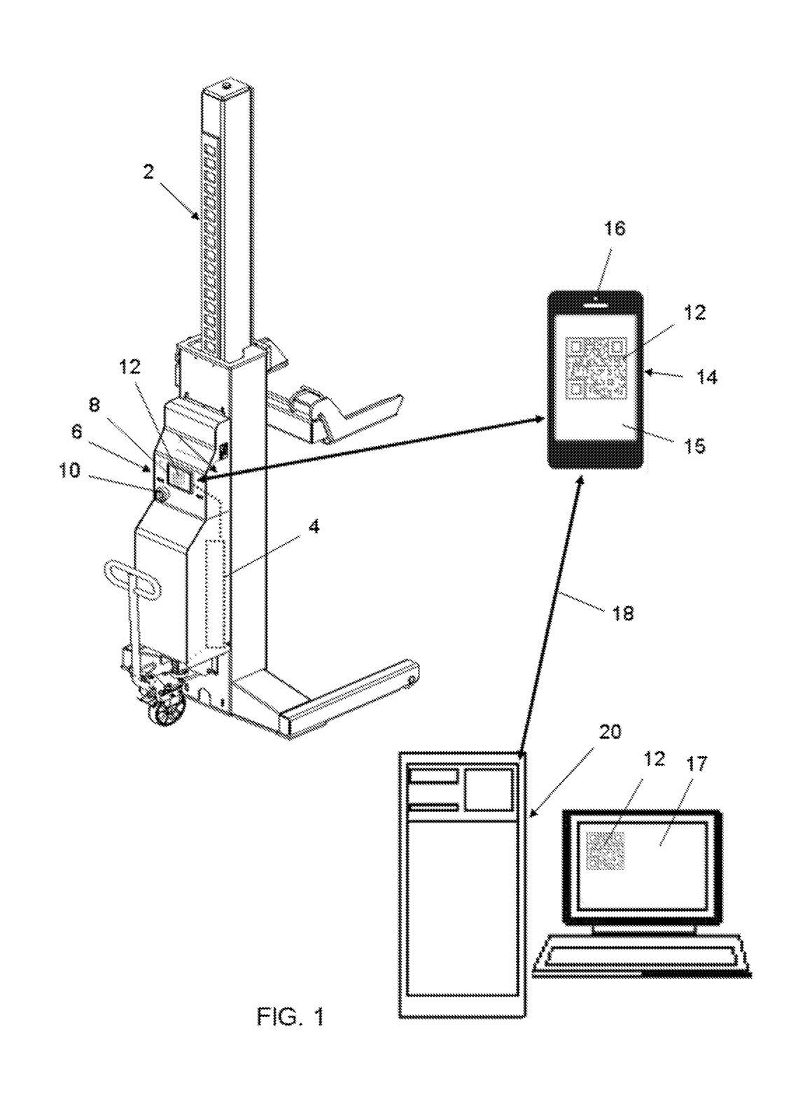

### DETAILED DESCRIPTION OF EMBODIMENTS OF THE INVENTION

As shown in the figures, the method according to the invention comprises a lifting and/or handling apparatus 2 of a load, preferably of motor vehicles and/or goods, which is mechanically and structurally substantially of traditional type.

The apparatus 2 comprises a processing unit 4, preferably implemented by means of at least one processor, and a user interface 6. Advantageously, the user interface 6 is either envisaged or associated with the apparatus 2 in a position in which is appropriately and easily visible and accessible by the operator.

In particular, the user interface 6 comprises a display device (display) 8 and a configuration panel 10 provided with input means which can be operatively activated by the operator to appropriately control said apparatus 2. For example, the user interface 6 may comprise a touchscreen and/or a display monitor associated with a keypad/push-button panel.

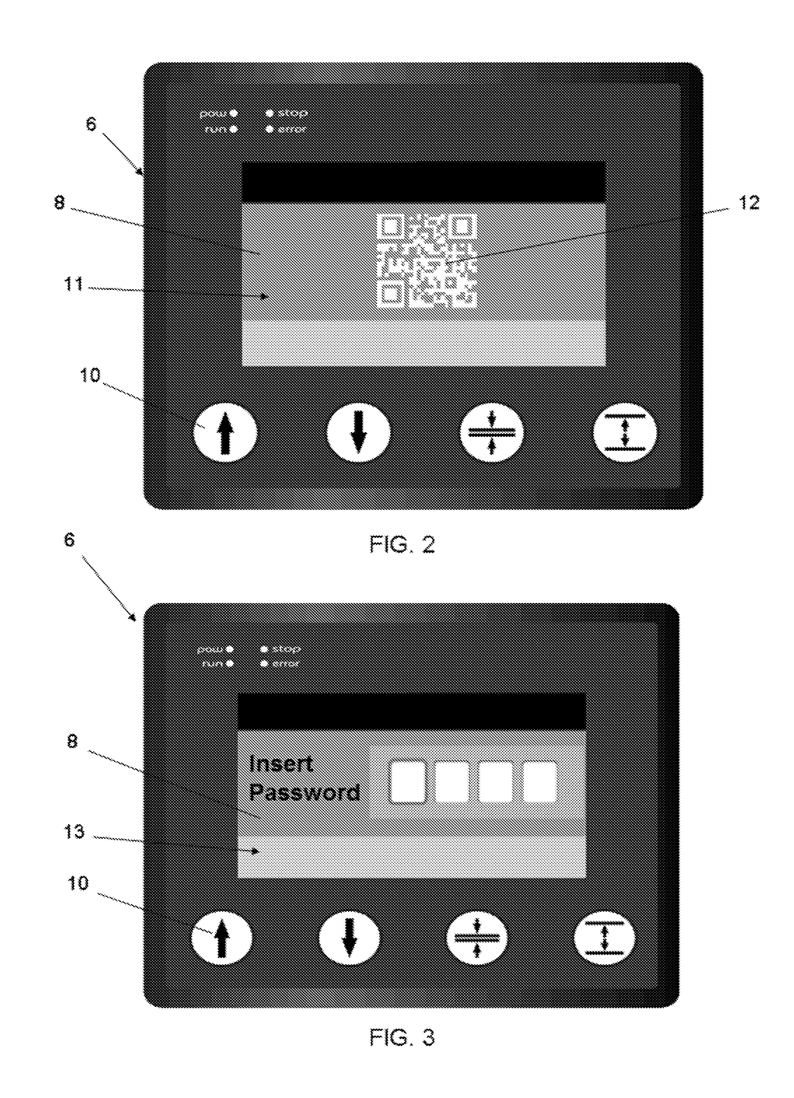

A first software module is loaded in the processing unit 4 of the apparatus, which software module receives in input a series of data, which are related to the state and/or to the effective operation or operative working state of the apparatus in at least one past or current working cycle, and encodes them so as to create, dynamically and preferably substantially in real time, a two-dimensional matrix barcode 12, which is then displayed on the display device 8 of the user interface 6 of the apparatus itself (cf. FIG. 2). In particular, working cycle means any movement of the apparatus 2 which occurs between two consecutive resting (i.e. stopping) states.

In different embodiments of the invention, the two-dimensional matrix barcode 12 is dynamically generated also by encoding data and/or fixed parameters of the apparatus 2, and may be displayed entirely in a single screen 11 of the display device (8) of the apparatus 2 or on multiple screens of the display device 8 of the apparatus 2.

Appropriately, the data which are contained and which define the two-dimensional matrix barcode 12 relate to the values of the dependent parameters and related to the effective operation of the apparatus 2 during a working cycle (e.g. during a lifting operation), either current or past, and/or dependent on and related to the current or past operative state of the apparatus 2.

Substantially, according to the present invention, the data related to the state and to the effective operation of the apparatus 2 are encoded in a two-dimensional barcode 12 which is displayed on the display device 8 of the user interface 6. In other words, the two-dimensional barcode 12 contains and is directly generated using the values of the parameters representative of the state and the effective operation of the apparatus 2.

Therefore, the two-dimensional bar code 12 is created by using the values of the parameters as they are detected by the corresponding sensors (e.g. weight, speed and position), with which the apparatus 2 is provided, and/or by using the values of the parameters which were processed and obtained starting from said sensors, without envisaging any querying of database or other memory elements. In particular, the values of said parameters are not fixed, and on the contrary change according to the effective working state of the apparatus 2 and, therefore, the two-dimensional barcode 12 generated by the first software module also changes correspondingly.

In particular, it is worth noting that two-dimensional matrix barcode means a “QR code” (acronym of “Quick Response”) or a “Data Matrix” code or any other two-dimensional barcode which consists of black modules arranged in a square or rectangular shape pattern.

Appropriately, the use of the two-dimensional matrix barcode 12 makes it possible to store a plurality of data securely in a single image, which is defined by a two-dimensional barcode (matrix) and which is displayed compactly on a single screen 11 of the display device 8.

Appropriately, the two-dimensional matrix barcode 12 may also be split across multiple screens of the display device of the apparatus 2.

Advantageously, the two-dimensional matrix barcode 12 is continuously and automatically regenerated by the software module run by the processing unit 4. Appropriately, the two-dimensional matrix barcode 12 is regenerated and/or displayed on the display device 8 of the user interface 6 whenever required by the operator and/or, preferably, is automatically regenerated whenever the state of at least one operative parameter of said apparatus 2 changes.

Advantageously, the two-dimensional matrix barcode 12 is regenerated with a preset refreshing frequency, e.g. of about 10 seconds. Preferably, the barcode 12 is automatically generated at each operating cycle of the apparatus 2, during and/or at the end such cycle.

Advantageously, the two-dimensional matrix barcodes 12 generated by the first software module, in addition to being displayed on the display device 8 of the user interface 6, are stored in the processing unit 4. Appropriately, by storing the two-dimensional matrix barcodes 12 the storage space for keeping track of the operative states and of the working functioning of the apparatus 2 is also optimized.

Appropriately, the two-dimensional matrix barcode 12, representing the state and/or the effective working operation of the apparatus 2, which is generated and modified each time, is stored in the processing unit and this makes it possible to monitor the apparatus 2 and create a log of its states.

Advantageously, the two-dimensional matrix barcode 12 is generated by the first software module on the basis of a plurality of data which comprise both values of the operative parameters related to the state and/or current working operation of the apparatus 2 and historical values of the aforesaid operative parameters, i.e. related to the state and/or past working operation of the apparatus itself.

Advantageously, the two-dimensional matrix barcode 12 is generated by the first software module by encoding the results of calculations and/or processes, of mathematical (e.g. an interpolation) and/or statistical type, performed starting from the data related to the state and to the effective operation of the apparatus 2. Appropriately, for this purpose, the processing unit 4 comprises a software module for performing the aforesaid mathematical and/or statistical calculations and/or processes.

Appropriately, the data related to the state and/or the effective operation of the apparatus 2 during the working cycle, data which are send in input to the first software modules and which are thus contained in the two-dimensional matrix barcode 12, and which thus defined it, comprise, for example:

the pressure, the speed and/or maximum height reached during the working cycle,

the lifted load and the route performed during the working cycle,

the number of columns active during the working cycle,

the activation modes of the columns, i.e. whether in group or on axis, during the working cycle,

the imbalances between columns which occurred during the working cycle,

the deviation of the column between actual positioning (i.e. that reached during the working cycle) and set positioning,

the number of activations of the solenoid valves during the working cycle,

the state of the solenoid valves,

the number of buttons activated during the working cycle,

the number of working hours performed in a given time window,

the battery charge state and the number of actual recharging operations.

Advantageously, the data which are contained and which define the two-dimensional matrix barcode 12 may also comprise, in addition to the parameters depending on the operation and operative state of the machine, fixed data related to the apparatus 2 (e.g. date of manufacture, firmware versions, software application versions, serial number etc.) and fixed parameters, such as, for example, the calibration parameter of the apparatus, such as connection type (via radio or via wire), maximum and minimum height value which can be reached by the column, maximum capacity, maximum permitted misalignment value of the columns etc.

Appropriately, it is further understood that multiple two-dimensional matrix barcodes 12, arranged in a tidy fashion on the screen itself and appropriately distanced apart may be displayed on a same screen 11 of the display device 8.

The method according to the invention also requires a device 14, preferably of portable type (mobile phone, smartphone, tablet, etc.), which is provided with optical detection means 16, e.g. a digital camera, for scanning and/or acquiring the two-dimensional matrix barcode 12 displayed on the display device 8 of the user interface 6 of the apparatus 2.

Advantageously, an appropriate reading/decoding program of the two-dimensional matrix barcode 12 which was acquired by the device itself by means of said detection means 16 may be loaded and run in the processor of the device 14.

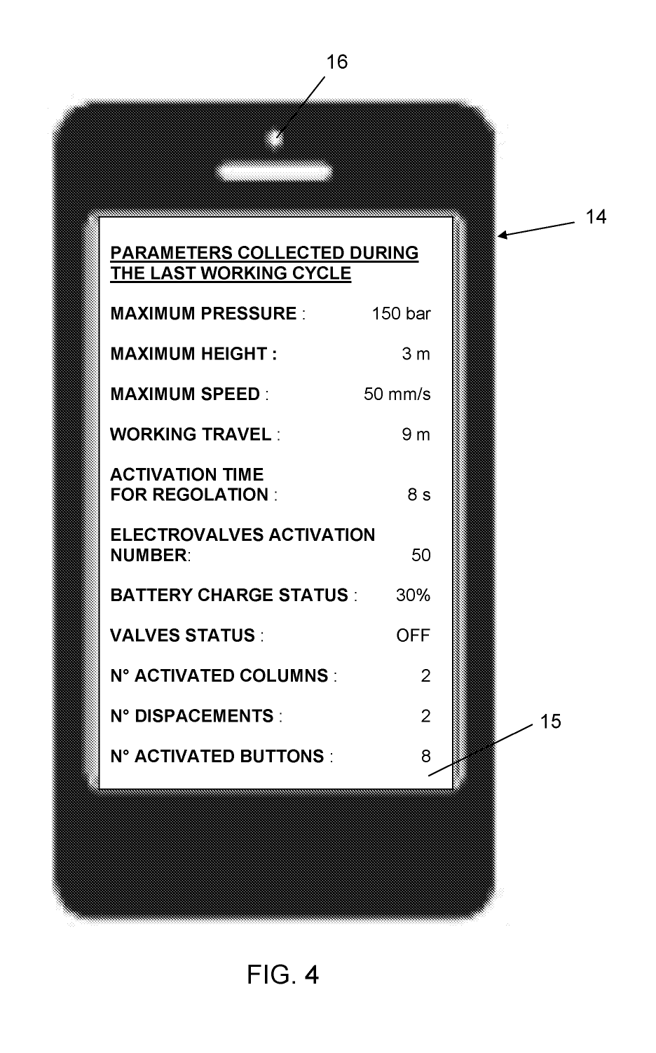

Appropriately, the reading/decoding program loaded and run in the acquisition device 14 may also be configured to show on the display 15 of the device itself the data contained in the two-dimensional matrix barcode in tidy and appropriately formatted manner (cf. FIG. 4). For example, the reading/encoding procedure is an appropriate mobile software application (app) loaded and run on a smartphone or tablet, also without requiring connection to the Internet (i.e. offline).

Preferably, the device 14 is provided with communication means 18 for sending the two-dimensional matrix barcode 12, acquired by means of the device 14, to a remote processing unit 20, e.g. a remote computer server, envisaged at a remote service center. In particular, these communication means may use mobile cellular telephone technology (with standards, such as for example GMS, UMTS, GPRS, etc.) and/or the Internet.

Advantageously, the reading/decoding program of the two-dimensional matrix barcode 12, which is sent by the device 14, is also loaded and run in the remote processing unit 20. Appropriately, the reading/decoding program loaded and run in the remote processing device 20 may also be configured to show on the display 17 associated with the remote processing unit 20, in tidy and appropriately formatted manner, the data contained in the two-dimensional matrix barcode.

Advantageously, the two-dimensional matrix barcode 12 may also contain an Internet address and the reading/decoding program may be appropriately configured to automatically send the operator, via the Internet and with an http protocol, to the Internet site page corresponding to the Internet address contained in said two-dimensional matrix barcode. Preferably, the data which are contained on and define the two-dimensional matrix barcode 12 are represented in tidy and appropriately formed fashion on such Internet page, which is displayed on the display of the acquisition device 14 or of the remote processing unit.

Otherwise, the two-dimensional matrix barcode 12 may contain data corresponding to an Internet address and, by reading/decoding the two-dimensional matrix barcode 12 using the reading/decoding program, the page of an Internet website identified by the Internet address contained in the two-dimensional matrix barcode 12 opens automatically on the display 15, 17.

Advantageously, a second software module is loaded and run on the remote processing unit 20 and/or in the portable device 14, in addition to the two-dimensional matrix barcode reading/decoding program, which second software module receives in input the data decoded and contained in the two-dimensional matrix barcode 12 and on the basis of a series of data stored and contained in a database for example and/or on the basis of possible further automatic processes performed by the module itself and/or on the basis of processes performed by the operator outputs to the user a series of useful information which is then appropriately sent and displayed on the display 15 of the device 14. Advantageously, such information concerns, for example, the calibration and/or maintenance operations to be performed. Appropriately, such information deriving from the analysis of the aforesaid data may also provide a prevision of the future behavior of the apparatus 2.

Appropriately, correct authentication by the operator is required for the operator to access the main screen of the display device 8 of the user interface 6 of the apparatus 2, on which the two-dimensional matrix barcode 12 is displayed, e.g. by means of an introductory screen 13 (cf. FIG. 3) on which the operator him or herself is required to enter an appropriate authentication password, e.g. by means of the input means 10 of the user interface 6.

Appropriately, one or more general data related to the apparatus itself and useful for the operator, such as for example date of manufacture, serial number and model of the current apparatus, serial number and replacement date of the previous apparatus, etc. may also be displayed on the screens of the display device 8 of the user interface 6 of the device 2 in traditional manner, i.e. by means of alphanumeric characters and thus without using encoding by means of two-dimensional bar code.

Advantageously, the method according to the invention may be used to provide information related to one or more apparatuses, for lifting and/or handling a load, which are used in workshops, in automatic or non-automatic vehicle parking systems, or more in general for lifting and moving goods.

From the above, it is apparent that the method according to present invention is more advantageous than the traditional ones because:

the acquisition of the data related to the state and/or effective working operation of the apparatus may be performed also during the normal operation thereof, thus avoiding the need to stop it and instead increasing the quality, quantity and relativity of the data which can be acquired,

it decreases costs because no Internet infrastructure dedicated to the apparatus itself needs to be implemented in the workshop or in the installation environment,

it uses accessibly priced acquisition devices which are already commonly found on the market,

it can also be used on mobile devices which are inherently difficult to connect to a fixed network,

it allows the easy identification and solution of malfunctions in real time, also by unqualified operators; in particular, by not showing any text message on the screen of the apparatus, translating such messages in a language known by the operator who physically acts on the apparatus itself is not required,

it makes it possible to easily acquire information related to the parameters which represent the state and effective operation of the apparatus, as well as those related to the possible log of the parameters themselves.

In particular, unlike EP 2927186 which uses the data of the operative state of the apparatus to query a local database in order to extract corresponding fixed and prestored information to be used to create the two-dimensional barcode, in the solution according to the invention the two-dimensional barcode is generated directly using the data related to the past and current state and effective operation of the apparatus during one or more working cycles. This is particularly advantageous because it makes it possible to simplify the hardware and software configuration to be mounted locally on the apparatus itself and above all to monitor the current operating state and the history of the apparatus, substantially in real time, in order to predict the onset of possible error situations or malfunctions by means of processes and/or remote servicing. Furthermore, according to the present invention, the maintenance and/or calibration instructions are defined/obtained outside the apparatus on the basis of the data/symptoms sent by the apparatus itself towards the outside by means of the two-dimensional barcode and this considerably simplifies the step of updating such instructions.

The invention claimed is:

1. A method for providing information related to an apparatus (2) for lifting or handling a load said apparatus (2) comprising a processing unit (4) and a user interface (6) with a display device (8), said method comprising:
displaying, on said display device, at least one two-dimensional matrix barcode (12), which contains data related to at least one operative working cycle of said apparatus (2),
wherein said at least one two-dimensional matrix barcode (12) is dynamically generated by software loaded and run on said processing unit (4) by encoding said data related to said at least one operative working cycle of said apparatus (2).

2. (canceled)

3. The method according to claim 1, wherein said data related to at least one operative working cycle of said apparatus (2) comprise data related to one or both of an effective operation or an operative state of said apparatus (2) during and/or at an end of said operative working cycle.

4. The method according to claim 1, wherein said at least one two-dimensional matrix barcode (12) is dynamically generated by encoding the data related to effective operative/working parameters of said apparatus (2).

5. (canceled)

6. The method according to claim 1, wherein said at least one two-dimensional matrix barcode (12) is dynamically generated/encoded in real time by said software loaded and run on said processing unit (4).

7. The method according to claim 1,
wherein said at least one two-dimensional barcode (12) is dynamically generated by encoding values of parameters detected by sensors with which the apparatus (2) is provided, or is dynamically generated by encoding values of parameters obtained from the data detected by the sensors with which the apparatus (2) is provided.

8. (canceled)

9. The method according to claim 1, wherein said at least one two-dimensional matrix barcode (12) is regenerated whenever required by an operator.

10. The method according to claim 1, wherein said at least one two-dimensional matrix barcode (12) is automatically regenerated whenever a state of at least one operative parameter of said apparatus (2) changes, or is automatically regenerated at a predetermined frequency, or is automatically regenerated at an end of said working cycle of said apparatus.

11. (canceled)

12. (canceled)

13. The method according to claim 1, wherein said at least one two-dimensional matrix barcode (12) is generated by a first software module is stored in the processing unit (4).

14. The A-method according to claim 1, wherein said at least one two-dimensional matrix barcode (12), which is dynamically generated by encoding the data related to the at least one operative working cycle of the apparatus (2), is stored in said processing unit (4) to create a log of the data related to operative working cycles of said apparatus (2), thus monitoring operation of the apparatus over time.

15. (canceled)

16. The method according to claim 1, wherein said at least one two-dimensional matrix barcode (12) is dynamically generated by encoding a result of calculations and/or processes, of mathematical and/or statistical type, performed starting from the data related to the at least one operative working cycle of the apparatus (2).

17. (canceled)

18. (canceled)

19. (canceled)

20. The method according to claim 1, wherein said display device (8) includes a screen, on which said at least one two-dimensional matrix barcode (12) is displayed, and which is accessed following an authentication step.

21. The method according to claim 1, wherein said two-dimensional matrix barcode (12) is acquired with a portable device (14) provided with optical detection.

22. The method according to claim 21, further comprising the steps of:
reading and decoding the two-dimensional matrix barcode (12) using a reading/decoding program loaded and run on said portable device (14), and
displaying the data thus encoded and contained in said two-dimensional matrix barcode (12) in a formatted manner on a display (15) of said portable device (14).

23. The method according to claim 21, further comprising the steps of:
sending the two-dimensional matrix barcode (12) acquired by said portable device (4) to a remote processing unit (20) using said portable device (14),
reading and decoding the two-dimensional matrix barcode (12) using a reading/decoding program loaded and run on said remote processing unit (20), and
displaying the data thus encoded and contained in said two-dimensional matrix barcode (12) in a formatted manner on a display (17) of said remote processing unit (20).

24. The method according to claim 21, further comprising the steps of:
reading and decoding the two-dimensional matrix barcode (12) thus acquired is using a reading/decoding program loaded and run on said portable device (14),
sending the data thus encoded and contained in said two-dimensional matrix barcode (12) to a remote processing unit (20 using said portable device (14), and
displaying the data thus received and corresponding to the data contained in said two-dimensional matrix barcode (12) in a formatted manner on a display (17) of said remote processing unit (20).

25. (canceled)

26. The method according to claim 21, further comprising the steps of:
loading a software module, which receives as input the data decoded and contained in the two-dimensional matrix barcode (12), on a remote processing unit (20) and/or inside the portable device (14), and,
outputting to a user, based on one or more of a series of stored data, on additional automatic processes performed by the software module, or on processes performed by an operator, a series of information of interest, which is then appropriately sent and displayed on a display (15) of the portable device (14).

27. The method according to claim 26, wherein said information of interest relates to one or more of calibration of said apparatus (2), maintenance or repair of said apparatus (2), or a forecast of future behavior of said apparatus (2).

28. (canceled)

29. An infrastructure for controlling an apparatus (2), comprising:
a processing unit (4);
a user interface (6) having a display device (8);
software loaded in said processing unit (4) of said apparatus (2) to implement a method comprising:
displaying, on said display device, at least one two-dimensional matrix barcode (12), which contains data related to at least one operative working cycle of said apparatus (2),
wherein said at least one two-dimensional matrix barcode (12) is dynamically generated by software loaded and run on said processing unit (4) by encoding said data related to said at least one operative working cycle of said apparatus (2).

30. The infrastructure according to claim 29, further comprising a portable device (14) provided with optical detection (16) and configured to acquiring said two-dimensional matrix barcode (12) with said portable device (14).

31. The infrastructure according to claim 29, further comprising a remote processing unit (20) configured to acquire said two-dimensional matrix barcode (12) using a portable device (14).
